(19) United States
(12) Patent Application Publication
(10) Pub. No.: US 2006/0265878 A1
(43) Pub. Date: Nov. 30, 2006

(54) Sports ball novelty item and method for forming

(76) Inventor: Jacqueline Zorman, Mountain Home, AR (US)

Correspondence Address: Kyla D. Cummings;SPEED LAW FIRM, Suite 1200, 111 Center Street, Little Rock, AR, 72201, US

(21) Appl. No.: 11/431,902

(22) Filed: May 10, 2006

Related U.S. Application Data
(60) Provisional application No. 60/679,877, filed on May 11, 2005.

(51) Int. Cl. B23P 19/04

(52) U.S. Cl. 29/896.411; 29/896.41; 29/433

(57) ABSTRACT

Embodiments include a novelty item comprising one or more strips of a material, the material being stitched together by stitching and each of the one or more strips including the stitching at least substantially along its length, wherein the one or more strips of material are formed from a sheet of material capable of forming the outer cover of a sports ball, and wherein the one or more strips of material are twisted into and set in a generally helical formation. Embodiments also include a method of forming a novelty item, comprising providing one or more strips of material, the material capable of forming an outside cover of a sports ball; wetting the one or more strips; twisting the one or more strips into a generally helical configuration; and allowing the one or more strips to dry in the generally helical configuration to form the novelty item.

### CROSS-REFERENCE TO RELATED APPLICATIONS

This application claims benefit of U.S. Provisional Patent Application Ser. No. 60/679,877, filed May 11, 2005, which is herein incorporated by reference in its entirety.

### BACKGROUND OF THE INVENTION

1. Field of the Invention

Embodiments generally relate to novelty items such as jewelry and methods for making the novelty items.

2. Description of the Related Art

Novelty items such as jewelry typically include a chain, string, or rope. These novelty items are usually made of metal, plastic, or string.

There is a need for novelty items such as jewelry which are related to sports.

There is a need for novelty items such as jewelry which are easily manufactured but aesthetically pleasing and functional.

### SUMMARY OF THE INVENTION

Embodiments of the present invention generally include novelty items which are constructed from a sports ball, a sheet of material resembling a portion of a sports ball, or a sheet of material which may have stitching thereupon. Embodiments of the novelty items include but are not limited to jewelry or a key chain. Embodiments further include a relatively simple method for making the novelty items.

Embodiments include a method of forming a novelty item, comprising providing one or more strips of material, the material capable of forming an outside cover of a sports ball; wetting the one or more strips; twisting the one or more strips into a generally helical configuration; and allowing the one or more strips to dry in the generally helical configuration to form the novelty item. Embodiments further include a method of forming a novelty item, comprising severing a strip of material from an outer cover of a sports ball; wetting the strip of material; twisting the wetted strip of material into a generally helical shape along at least a portion of its length; and allowing the strip of material to dry in the generally helical shape, wherein the novelty item is permanently set in the helical shape upon the drying of the strip of material.

Yet further embodiments include a novelty item, comprising one or more strips of a material, the material being stitched together by stitching and each of the one or more strips including the stitching at least substantially along its length, wherein the one or more strips of material are formed from a sheet of material capable of forming the outer cover of a sports ball, and wherein the one or more strips of material are twisted into and set in a generally helical formation.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a section view of a strip of material for forming a novelty item.

FIG. 2 is a perspective view of a necklace.

FIG. 3 is a perspective view of a pair of earrings.

FIG. 4 is a perspective view of a keychain.

FIG. 5 is a perspective view of a watch.

### DETAILED DESCRIPTION

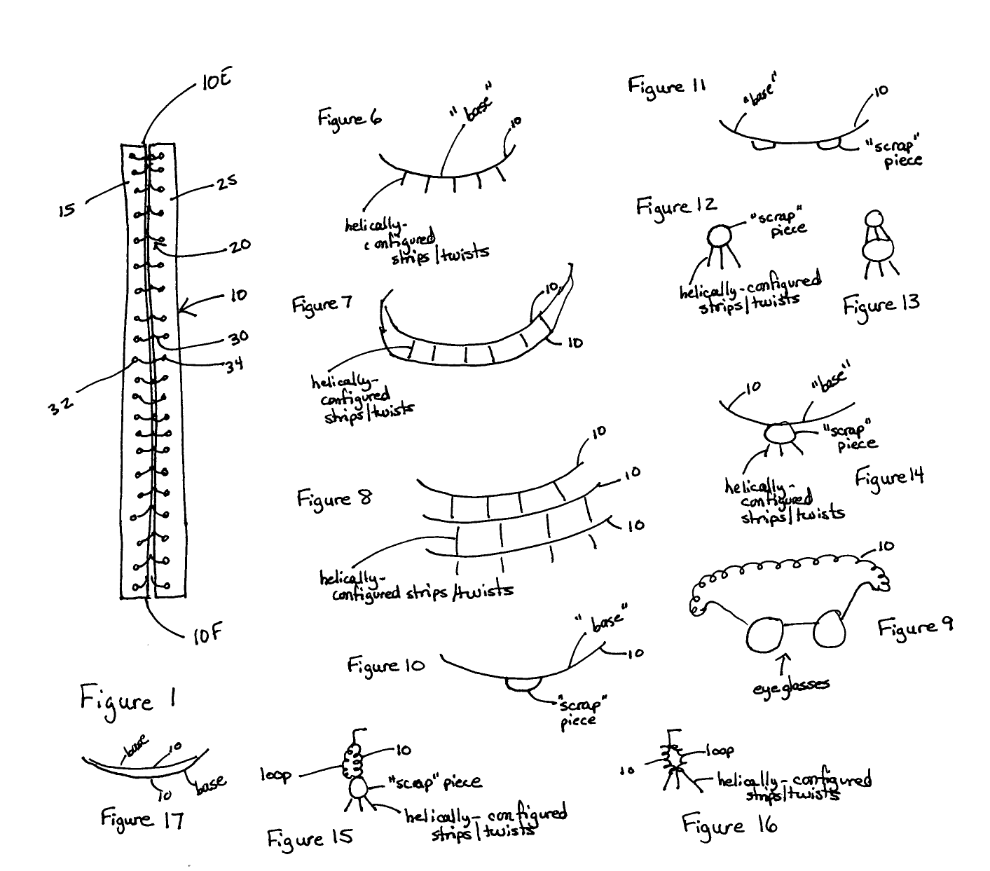

Embodiments of the present invention include novelty items formed from one or more strips of material, such as the strip 10 shown in FIG. 1. The strip 10 of FIG. 1 may be cut or severed from an outside cover of a sports ball (e.g., a baseball or softball) or from a sheet of material usable as the outside cover of the sports ball. In the alternative, the strip 10 may simply be previously formed in the shape shown in FIG. 1 (and stitched as shown), or a sheet may be formed in another shape and cut into the shape shown in FIG. 1. Other shapes for the strip 10 which are different than the shape shown in FIG. 1 are also within the scope of embodiments.

As shown in FIG. 1, a first portion 15 of the strip 10 is located generally adjacent to a second portion 25 of the strip 10, and the first and second portions 15 and 25 are operatively connected to one another by stitching 20 using one or more threads 30. The first portion 15 includes one or more holes 32 therethrough, while the second portion 25 includes one or more holes 34 therethrough. The stitching 20 connects the first and second portions 15 and 25 upon placement of one or more threads 30 through generally adjacent holes 32 and 34.

In one embodiment, the strip 10 is made of leather, faux leather, or other material having similar properties to leather, for example such as is present on the outside cover of a sports ball. Other materials used to form sports balls (especially the outer covers of sports balls) may also be used to form the novelty items of embodiments.

Preferably, the stitching 20 runs generally parallel to the length of the strip 10 and is most preferably (although not necessarily) centered on the strip 10. As in most sports balls, the stitching 20 may be of a different color than the strip 10 of material for aesthetic purposes, for example the stitching 20 may be red and the strip 10 may be white, as in a typical baseball or softball.

Although shown in FIG. 1, the strip 10 of material does not necessarily include the stitching 20 and may be made of only one piece of material rather than the two separate portions 15, 25.

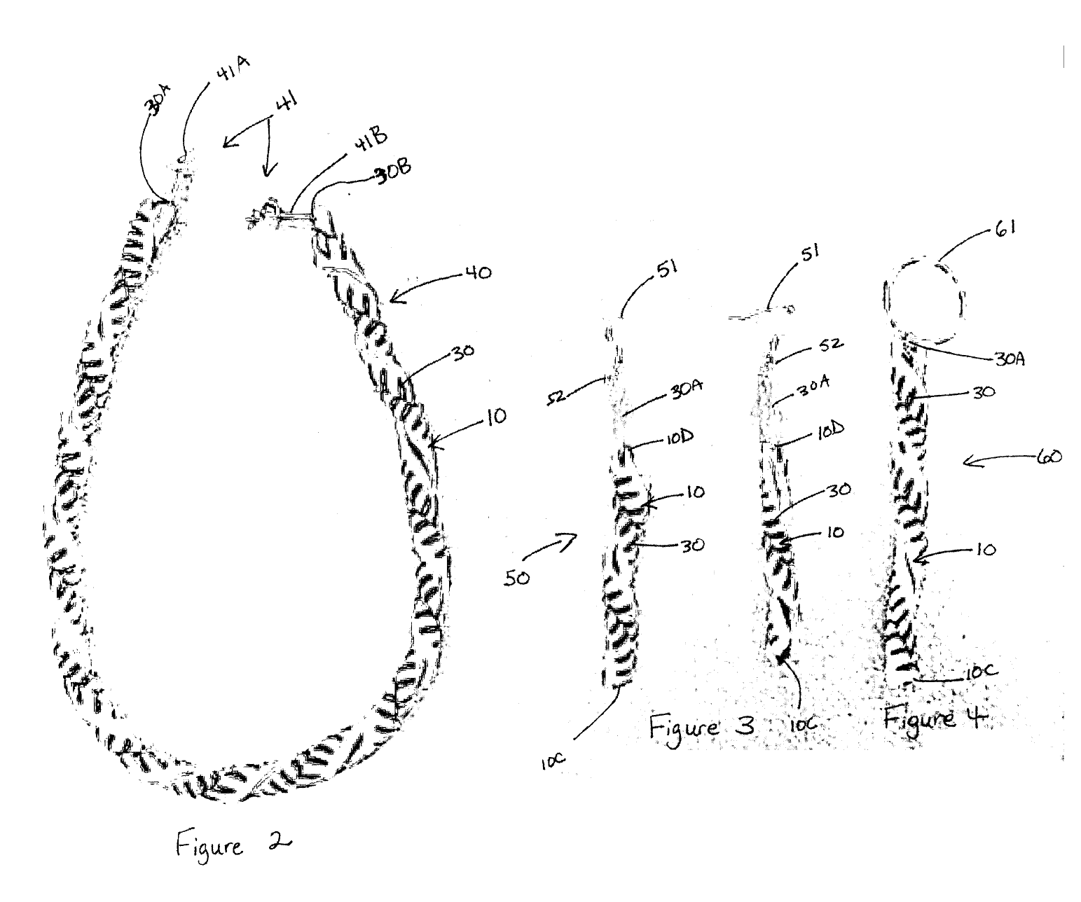

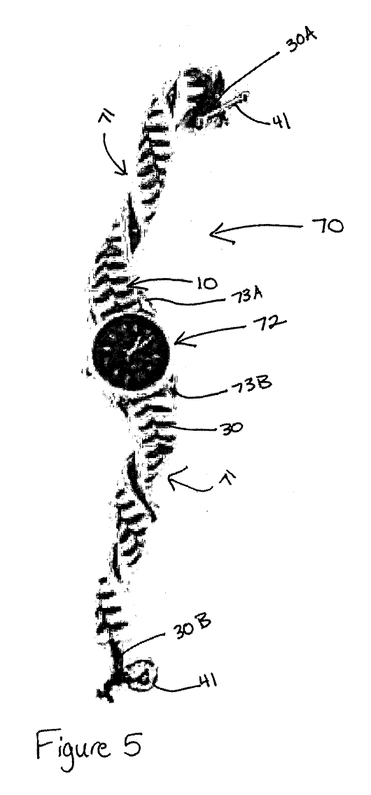

FIGS. 2-5 illustrate various novelty items which are within the scope of embodiments of the present invention. FIG. 2 shows a necklace 40, FIG. 3 shows a pair of earrings 50, FIG. 4 shows a keychain 60, and FIG. 5 shows a watch 70. Other novelty items within the scope of embodiments of the present invention include (but are not limited to) one or more anklets, bracelets, rings, watch bands, hair ties, clothing/bag decorations, or eye glass holders/bands.

In all of the depicted novelty items of FIGS. 2-5, the strip 10 forms a portion thereof. In FIG. 2, the necklace 40 includes the strip 10 as its chain. Each of the earrings of FIG. 3 and the keychain of FIG. 4 include the strip 10 as decorative portions thereof. One or more strips 10 form the watch band 71 portion of the watch 70 of FIG. 5. The one or more strips 10 are preferably formed in a generally helical or spiral configuration and set in this formation, as shown in FIGS. 2-5. Most preferably, no external support mechanism is needed to hold the one or more strips 10 in this helical/spiral configuration once the configuration is set as described below.

Various functional members may optionally be operatively connected to the novelty items. In the necklace of FIG. 2, one or more connecting members such as clasps 41 may optionally be operatively connected to each end of the strip 10 for connecting the ends of the necklace 40 to one another, for example upon placement of the necklace 40 around the user's neck. Any type of clasp known to those skilled in the art may be utilized to connect portions of the novelty items to one another. In the embodiment shown in FIG. 2, the clasp portions 41A, 41B are connected to the ends 30A and 30B of the thread(s) 30 of the stitching 20. In the alternative, the clasp portions 41A, 41B may be directly connected to the ends of the strip 10, or the clasp 41 may be eliminated and the loose ends 30A and 30B of the thread(s) 30 may be tied together to “clasp” the necklace 40 at its ends, for example upon placement around the user's neck. Similar clasping or tying techniques may be utilized when the novelty item is a bracelet, anklet, ring, hair tie, or similar item needing connection at its ends.

The watch 70 shown in FIG. 5 is similar to the necklace 40 of FIG. 2 in that the ends of the one or more strips 10 may be connected using a clasp 41 or by tying thread ends 30A, 30B together, for example upon placement of the watch 70 on the user's wrist. The watch 70 includes one or more strips 10 which are helically/spirally arranged as shown and a watch mechanism 72. The watch mechanism 72 includes all of the components of a typical watch known to those skilled in the art (except the watch band, which is replaced at least partially by the one or more strips 10), including the watch face, hands, timing mechanism, batteries (or other powering member), etc. Preferably, the one or more strips 10 are connected to the watch mechanism 72 as shown in FIG. 5, where an end of each strip 10 is threaded through one or more brackets 73A, 73B which either form a part of or are operatively connected to the watch mechanism 72. The ends of the threaded strips 10 may then be operatively connected to the back-side of an un-threaded portion of the strip 10, for example by sewing each end or a portion of the strip 10 close to each end to a back-side portion of the strip 10. In other embodiments, the strips 10 may be connected to the watch mechanism 72 using any other method known to those skilled in the art for connecting a typical watch band to a typical watch mechanism 72.

In other embodiments, the watch mechanism 72 of FIG. 5 may be replaced with a charm or other decoration to form a bracelet. The decoration may be of any shape or configuration.

FIGS. 3 and 4 illustrate the use of one or more helically-configured strips 10 to form a decorative portion of the novelty item. In FIG. 3, strips 10 form decorative portions of a pair of earrings 50. In FIG. 4, one or more strips 10 form the decorative portion of a keychain 60.

Each earring shown in FIG. 3 includes a helically-configured strip 10, where one end 10C of each strip 10 remains unconnected (but may include a decoration of some sort operatively connected thereto), and the other end 10D of each strip 10 is operatively connected to an ear engagement member 51 which allows connection of the earring 50 to the hole through the user's ear. The ear engagement member 51 may be directly connected to the strip 10 or may be connected as shown in FIG. 3 so that the ear engagement member 51 is tied to the strip 10 by use of an exposed end 30A of the thread 30 of the stitching 20 through a loop 52 in the distal end of (or elsewhere on) the ear engagement member 51. Optionally, glue may be utilized to more permanently connect the thread end 30A to the loop 52 or as the only connection means of the ear engagement member 51 to the strip 10 or thread end 30A. Any other connection method for connecting an ear engagement member 51 to an earring portion which is known to those skilled in the art may instead by utilized.

In an alternate embodiment, the earring ends 10C may be looped and also connected to the ear engagement member 51, for example by gluing or tying, or the earring ends 10C may be looped and connected to another portion of the strip 10. In a further alternate embodiment, multiple strips 10 helically disposed may be operatively connected to the ear engagement member 51.

The keychain 60 of FIG. 4 includes at least one strip 10 with an unconnected end 10C as well as an end 10D which is operatively connected to a key holder 61. In alternate embodiments, the end 10C may be connected to a decorative member or functional device (e.g., flashlight or whistle) or may be looped and also connected to the key holder 61 or connected to a backside portion of the strip 10. The key holder 61 may be connected directly to the strip 10 or may be connected to the strip 10 via the thread end 30A, as depicted in FIG. 4. In the shown embodiment, the thread is looped around the key holder 61 and either tied around a remaining portion of the thread 30 or connected to the strip 10. As mentioned above with respect to the earrings 50, alternate embodiments of the key chain 60 may include multiple strips 10 connected at least at one end to the key holder 61.

The helical configuration of the strip 10 of the novelty items shown in FIGS. 2-5 is formed as follows. First, the strip 10 is provided, preferably by severing a portion of an outer cover of a baseball, softball, or other similar sports ball. The strip 10 may be provided by cutting from either the actual sports ball outer cover or a sheet which is either intended to form the outer cover of the sports ball, has material stitched together in the general manner that a sports ball is stitched, or merely has material stitched together for the purpose of cutting to form the novelty item. In the alternative, the strips 10 may be initially constructed in their eventual size and stitched together generally as depicted.

The strip 10 is then wetted with any liquid substance (but preferably water or a water mixture). The liquid substance is preferably but not necessarily hot or warm in temperature (at least above room temperature) when wetting. Either during the wetting or after the wetting, the strip 10 is twisted so that a first portion of the strip 10 is rotated relative to a second portion of the strip 10, where the desired helically-configured portion is between the two portions of the strip 10. In the shown figures, a first end 10E of the strip 10 is turned/twisted relative to a second end 10F of the strip 10, so that the first end 10E forms the first portion described previously and the second end 10F forms the second portion described previously (see FIG. 1). The turning/twisting may be accomplished either manually or by a mechanical device capable of gripping the first and second portions of the strip 10 and twisting the portions relative to one another.

Once the portions of the strip 10 are twisted/turned to provide the desired amount and size (i.e., diameter) of helixes on the strip 10, the portions (e.g., the ends 10E, 10F) are held (either manually or by one or more devices, such as pins) in that position until the strip 10 is at least substantially dry. The drying of the strip 10 in this helical formation sets the strip 10 in this configuration. Although the use of other external supporting mechanisms for maintaining the helical formation of the strip 10 is within the scope of embodiments of the present invention, it is not necessary to utilize any supporting mechanisms in order for the strip 10 to remain in this helical formation.

The step of wetting of the strip 10 may be accomplished either by soaking the strip 10 in a liquid solution or substance or by spraying or pouring the liquid solution/substance on the strip 10. Most preferably, the strip 10 is soaked and at least substantially saturated with the liquid substance. The step of twisting of the portions of the strip 10 to result in the helical formation may be done either before, during, or after wetting the strip 10. The drying step may either include air drying or drying with a drying device, such as a fan or other drying device known to those skilled in the art.

Any or all of the above steps in the method of forming the helically-configured strip 10 may be performed either manually or automatically. In one embodiment, an automized system, which may include conveyors, performs all of the steps mentioned above, including forming the strip 10, wetting the strip 10, and setting the strip 10 by drying and holding the strip 10 in the helical configuration.

In any of the embodiments described above, one or more charms or other decorations (including one or more additional helically-configured strips, which may be smaller than the base strip 10) may be hung from the strip 10, and the one or more charms may be any known to those skilled in the art and/or additional helical or non-helical strips. In alternate embodiments, any of the strips 10 described above may include the material of the strip 10 without the stitching 20 (may be one solid piece of material). Also in alternative embodiments, any of the strips 10 may be multiple pieces of material connected to one another through any method other than stitching 20. In other embodiments, any of the strips 10 may be constructed from sports ball material or similar material and not helically configured (e.g., generally flat or configured in other shapes). Further alternate embodiments may include only shaping (e.g., helically) a portion of the strip 10 in the desired configuration using the above method. Other alternate embodiments include forming the novelty item (e.g., the necklace) by operatively connecting two or more helically-configured strips to one another at one or more locations (e.g., the ends of the strips) to form a tiered novelty item (see FIGS. 17, 7, and 8).

If a clasp is used in any of the embodiments, once the clasp is operatively connected to the novelty item, excess string (thread) may optionally be cut off for a neat appearance. Also, before or after applying clasps, beads may optionally be added to the novelty item for decoration.

Possible embodiments of novelty items include the following, which are merely examples of novelty items within the scope of embodiments of the present invention and are not in any way limiting to the scope of embodiments of the present invention: a necklace, anklet, watch band, or bracelet (which may either include the strips 10 described above or may instead include a typical chain, plurality of beads, or other necklace, anklet, bracelet, or watch band body known to those skilled in the art) with smaller twists (helically-configured strips 10) hanging therefrom (see FIG. 6); a watch band where watch band ends fold under and thread is secured through the present hole; an eyeglass holder (see FIG. 9); or a necklace, bracelet, anklet, or watch with additional (may be smaller) pieces to make a two or three-tiered piece (see FIGS. 7 and 8).

In one exemplary embodiment, a necklace, bracelet, anklet, or watch may be formed in the following manner: one or more pieces (which may for example be helically-configured strips 10 used for earrings) are provided, turned lengthwise, and hung from the necklace, bracelet, anklet, or watch (see FIG. 6). Optionally, a non-helically configured piece of the strip 10 may also (or instead) be hung from a portion (e.g., at or near the center) of the necklace, bracelet, anklet, or watch (see FIGS. 10 and 11), and also optionally an imprint and/or design can be printed on any of the pieces hung from the necklace, bracelet, anklet, or watch or on the necklace, bracelet, anklet, or watch itself.

Any of the strips 10 or other portions of the novelty items described in any of the above embodiments may optionally be painted, stitched, or imprinted with sports team insignias, name brand logos, or any other designs. Any color combination of the strip 10 and stitching 20 is within the scope of embodiments, but some non-limiting examples include any combination of pink/purple, neon green/yellow, blue/gold, sports team colors, etc. Any at least substantially full grain leather or faux leather ball for any sport may be utilized with embodiments described above, including but not limited to a football, basketball, volleyball, lacrosse ball, baseball, softball, soccer ball, or any other patterned or stitched sports ball.

As mentioned above, the process for forming the novelty item may be effectively performed without cutting the leather (or faux leather) from the sports ball. Technology for stitching sports balls may optionally be utilized to pre-stitch two or more pieces of leather (or faux leather) to resemble a cut sports ball.

A preferred method of forming the novelty item is as follows (this preferred method does not limit the scope of embodiments of the present invention). A full grain leather baseball or softball is cut down one side of the stitches using a utility knife, and the same is done on the other side of the stitches. The stitches and leather are then pulled from the ball. Any remaining filler is then separated from the underside of the ball (laces and leather) to determine where the stitching was started and ended. A pair of jewelry pliers is next utilized to pull some stitches (e.g., a couple of stitches) out of the laces. The excess leather is cut, and then the leather with laces attached thereto is wetted using hot water (warm or cold water may not work as well). The leather with laces attached thereto is then twisted to form a spiral. The twisted strip is pinned to a board to dry. The leather may instead be twisted periodically as it dries so that it will stay twisted. Once the leather dries, it remains twisted even if wetted again.

When using a baseball or softball, the full length of the stitching may be used to form a necklace. An optional method for forming an anklet or bracelet includes fitting the anklet or bracelet to the user's ankle or wrist by measuring the respective areas and cutting the anklet or bracelet to the measured size. In the alternative, after the anklet or bracelet is wrapped around the ankle or wrist, the strip may be cut longer than needed and the laces pulled out until the desired length is reached. The excess leather may then be cut off and the end laces decorated and fastened as described above.

An optional method for forming the key chain includes pulling the laces out of some extra stitches for a longer string at one end of the strip after the strip is twisted. The opposite end is cut a little longer than desired, some stitches are pulled out, and excess leather is cut. Then the string (thread) may either be tied very closely to the leather and the thread ends hidden under the coils, or in the alternative beads or other items may be added to the string and then the string tied off. A key ring (key holder) is then added to the key chain.

Optionally, an eyeglass band may be formed using the same process as used for the necklace except that the lenses/framed lenses may involve tying the string/thread or for fasteners, adding the pieces that attach the earpieces on each of strings/threads. The strings/threads may also optionally be decorated with beads and other items.

A possible method for making the watch band involves sizing the watch band as described above in relation to the necklace, bracelet, anklet, etc. To perform this optional method, place one end around the pin (this part of the strip will be laying flat). Separate the laces into groups of two. With jewelry pliers or an extremely heavy needle, open a hole on the top a little wider. From the bottom of the piece, push or pull the thread through the hole, then do the same to the hole directly across from the first hole. Gather all laces together. Place them over the closest center stitch. Pull through both the top and bottom pieces. Tie ends in knot, cut off excess strings or hide in twist, and repeat on other side. There may be a need to cut in half, pull out laces, and fasten to clasp(s) of some sort in the same way as to watch pins.

Earrings may be formed in generally the same manner as the key chain, and the strings/threads may optionally be decorated with beads and other items and the bottom end tied off. If no items are attached, an optional method is as follows. Tie ends close to the bottom of the earrings and either cut excess string or hide in the twist. Push the top end(s) of strings/threads through the hole in the earring fastener. If the earring fastener is for clip-on earrings, tie strings together, cut off excess thread, and glue knot to earring back.

An optional method for making a necklace, bracelet, or anklet (or watch band) with additional pieces (which may be smaller than the base piece) is as follows. Use one long, twisted leather (or other material) piece for the base (the base is the basic necklace, bracelet, or anklet already made using the twisting process described above). Cut and make twisted pieces (preferably small) as described for the key chain (only preferably smaller). In the preferred method, do not tie or cut off extra string ends, and make longer than normal top string ends to have something to work with. Decide how many and where to place the pieces. Tie bottom ends close to leather and hide strings in the windings. Divide top strings into two parts. Thread one set through the first hole using method described for watch. Do the same with the other set of strings in the hole directly opposite the first hole. Fasten as if for the watch string. Continue along length of base until satisfied. Optionally, add beads and similar decorative items to the smaller pieces before adding to the base or tying off the bottom ends.

The following describes an optional method for forming a tiered necklace, bracelet, or anklet (see FIGS. 7, 8, and 17). Match two or more bases so they are the same or similar length and configuration. Fold the first necklace into thirds or fourths (or in half or other proportions). At these “folded” points, place the smaller cut pieces as described above. The difference is that the bottom strings preferably are not tied or ended on bottom and the strings are left long. Once the top base and the pieces are attached, make sure the bottom piece (base) matches and attach the smaller pieces to bottom base. Bring string ends of bases together and add clasp of choice. Optionally, wind string of choice around ends to hold together to make a tie necklace (tie ends together to fasten). The following optional variations to this method include adding a third tier using this method, making a tiered necklace with small twisted pieces as previously described, making a double or triple row necklace, anklet, bracelet, or watchband by matching up lengths, clasping or wrapping ends together, and proceeding as aforementioned.

The following describes an optional method for making more elaborate earrings (see FIGS. 12 and 13). Using excess thread from both ends after making the base the desired length (or additional thread), put string together to form an at least substantially circular shape or other shape. Place through hole on earring mount or tie and then add glue to hold to mount. Optionally, add beads and/or other decorative items and ends before placing string through or on mount. The user may either wear like this or add dangle pieces to earrings as described in relation to making a dangle necklace.

When making any of the novelty items described above, to optionally put the “scrap” pieces to work, cut the piece in half or just cut a circle out from each end (see FIGS. 10-14). This piece may optionally be stamped, painted, or imprinted with words such as “I love you”, names of children for mother's necklace, or team name; stamped, painted, or imprinted with pictures or designs such as a team logo or business name or logo; or stamped, painted, or imprinted with both words and a design or logo. Once the piece is decorated as desired, punch holes (e.g., two holes) at a distance (e.g., equidistance) from the ends just below the top. Take a piece of thread, fold in half, thread through one hole, and pull ends through the loop. Do the same to the other side (more holes may be punched to make stitching look like stitching on base). Find the center on the base of a necklace, anklet, or bracelet, pull the thread from the scrap through the holes as described previously, and end the same way. Optionally, add beads and/or other similar decorations before attaching the base. It is possible to add more than one “scrap” piece in same manner as described above and strategically place the pieces. Optionally, add beads and/or other decorative items before adding to base.

Using the base and “scrap” circle/piece already attached, smaller twisted pieces may be attached by making these pieces in the manner of the key chain and placing the top strings in holes punched in the bottom of the “scrap” circle/piece (see FIGS. 12-14). Beads and/or other similar decorative pieces may be added before attachment and to bottom strings before ending and tying.

“Scrap” piece earrings may be formed in the following manner. Take a circle piece and glue it directly to an earring back, or poke holes in top and thread as previously described, and attach to a back with the strings. Optionally, decorate the piece as previously described by stamping, imprinting, or painting. Also optionally, poke holes in bottom and attach another piece or several pieces, adding beads onto strings if desired. In the alternative, add beads to strings before attaching to base of necklace.

Another method for forming the “scrap” earrings involves taking the first “scrap” piece attached to the earring back, poking holes in bottom, and adding small twisted pieces in the manner previously described. Beads and/or other decorative items may optionally be added before putting the twisted pieces on the earrings.

The earrings may also be formed by starting with “scrap” pieces and alternating with twisted pieces until the desired length and look is reached, adding beads and other similar decorative items to the string if desired.

In an exemplary method for forming an embodiment, make a base the desired length and gather ends to form a loop with the twisted piece (see FIG. 15). Add a “scrap” circle/piece already threaded to loop by threading through punched holes in twist. Optionally, add beads on threads of twist and/or threads on “scrap”, and/or add twists of “scrap”. Form holes in bottom of “scrap” circle/piece. Add twists as aforementioned. Optionally, add beads and/or other decorations to strings as desired.

Another embodiment involves taking the earring loop and attaching one or more twists directly to the loop (see FIG. 16). Optionally, add beads and/or other decorations to twist strings.

In alternate embodiments, any type of leather may be utilized to stitch two or more strips together, wet, and twist as in the aforementioned items, for example in forming western motifs, design, and jewelry. In other embodiments, a hat band may be formed instead of necklaces in the above-described manner.

In any of the embodiments, the strip(s), either before of after being twisted, may be painted, stamped, or imprinted with pictures, words, logos, and/or team insignias or names. Many different color combinations are possible by using different colored leather and laces (e.g., pink/powder blue, gold/lime green, black/red).

Another embodiment involves taking the base and making a ring using the following optional method. After twisting, cut the base slightly longer than the desired length. Leave long strings on the uncut end. Where cut, pull strings out until desired length of leather is reached. Cut away excess leather. Wrap base around finger and tie. Optionally, glue base to an already-made ring to form a metal (or other common material) ring (but glue is not necessary to hold base together).

Other optional methods and configurations of embodiments are described below. In one embodiment, the base may be twisted in two different directions after cutting, stripping, and wetting. Hold base in middle. Twist from middle up one side while holding middle. While holding the twist already done, work up the other side in an opposite direction. This twist may be alternated throughout the necklace.

Another embodiment includes a kit having instructions and materials for forming any of the novelty items described above, or a kit including the instructions for forming a novelty item, possibly with a list therein of materials needed.

In an embodiment, western jewelry such as necklaces, bracelets, rings, watches, and/or anklets may be formed by hanging one or more western-looking items from the base. One or more western-looking items may also be added to the earrings and key chains or other novelty items. In another embodiment, three or more pieces of leather and/or twists may be stitched to the novelty item.

In another embodiment, these twisted pieces of leather and stitching can be added to clothing for decoration and embellishment, for example to provide zipper pulls or fringe, to embellish pockets, or to decorate down the sides (or other portions) of jeans, other pants, jackets, shirts, other clothing items, or bags/purses.

Other embodiments involve using the helically-configured strip(s) to form or decorate a novelty item such as a pony-tail holder. One method for forming/decorating the pony-tail holder involves taking a base piece, estimating how long is needed to wrap around a pony-tail holder (or to form the pony-tail holder itself), cutting longer than needed, pulling out strings, and cutting excess material. Wrap twisted base around holder, tie ends, hide end in twist, and wear in hair.

A shirt scrunchie as the novelty item may be constructed using same principle as described above for a pony-tail holder. Figure out length needed. Pull strings and cut excess material. Place through neck and sleeve of shirt, and then tie strings.

Yet another embodiment of a novelty item includes ornaments. In one method for forming an ornament, take generally equal length pieces with long strings and shape as a bird cage. Tie string ends together. Optionally, trim knot for a neat appearance, leave long for tassel appearance, or pull into “ball” for an inside tassel effect. Also optionally, add charms to hang inside the ornament or from the tassels.

While the foregoing is directed to embodiments of the present invention, other and further embodiments of the invention may be devised without departing from the basic scope thereof, and the scope thereof is determined by the claims that follow.

1. A method of forming a novelty item, comprising:
providing one or more strips of material, the material capable of forming an outside cover of a sports ball;
wetting the one or more strips;
twisting the one or more strips into a generally helical configuration; and
allowing the one or more strips to dry in the generally helical configuration to form the novelty item.

2. The method of claim 1, wherein the novelty item is jewelry.

3. The method of claim 2, further comprising operatively connecting one or more clasps to one or more ends of the one or more strips of material.

4. The method of claim 1, wherein providing one or more strips of material comprises removing the material from the outside cover of the sports ball.

5. The method of claim 4, wherein removing the material from the outside cover of the sports ball comprises cutting the material into the one or more strips.

6. The method of claim 5, wherein cutting the material into the one or more strips comprises cutting the material into one or more strips wherein a stitching of the outside cover of the sports ball is located within the one or more strips.

7. The method of claim 6, wherein the one or more strips of material are cut generally parallel to the stitching.

8. The method of claim 1, wherein wetting the one or more strips of material comprises saturating the one or more strips with water.

9. The method of claim 1, wherein the novelty item is a key chain.

10. The method of claim 1, further comprising:
wetting the one or more strips;
un-twisting and flattening the one or more strips; and
allowing the one or more strips to dry in a generally straightened configuration.

11. The method of claim 1, wherein the one or more strips of material are made of leather.

12. The method of claim 1, wherein the one or more strips comprise a plurality of strips.

13. A novelty item, comprising:
one or more strips of a material, the material being stitched together by stitching and each of the one or more strips including the stitching at least substantially along its length,
wherein the one or more strips of material are formed from a sheet of material capable of forming the outer cover of a sports ball, and
wherein the one or more strips of material are twisted into and set in a generally helical formation.

14. The novelty item of claim 13, wherein the novelty item is a piece of jewelry.

15. The novelty item of claim 13, wherein the one or more strips of material are set in the generally helical formation by wetting the one or more strips and allowing the wetted strips to dry in the helical formation.

16. The novelty item of claim 15, wherein the one or more strips of material, when set in the generally helical formation, provide sufficient support themselves to retain the one or more strips of material in the helical formation.

17. The novelty item of claim 13, wherein the stitching is generally centered on the one or more strips.

18. The novelty item of claim 13, wherein:
the one or more strips comprise a plurality of strips of material; and
the plurality of strips of material are intertwined with one another to form a generally helical shape.

19. A method of forming a novelty item, comprising:
severing a strip of material from an outer cover of a sports ball;
wetting the strip of material;
twisting the wetted strip of material into a generally helical shape along at least a portion of its length; and
allowing the strip of material to dry in the generally helical shape, wherein the novelty item is permanently set in the helical shape upon the drying of the strip of material.

20. The method of claim 19, wherein the novelty item is permanently set in the helical shape upon the drying of the strip of material without the need for any external support.
